(19) United States
(12) Patent Application Publication
(10) Pub. No.: US 2025/0299591 A1
(43) Pub. Date: Sep. 25, 2025

(54) User Manual System with Integrated AI Co-Pilot

(71) Applicant: LiveX AI Incorporated, Palo Alto, CA (US)

(72) Inventors: Jia Li, Palo Alto, CA (US); Yao Zhao, Fremont, CA (US); Yujia Li, Palo Alto, CA (US); Seokhwan Cho, Sunnyvale, CA (US)

(21) Appl. No.: 19/078,146

(22) Filed: Mar. 12, 2025

Related U.S. Application Data
(60) Provisional application No. 63/566,281, filed on Mar. 17, 2024.

(51) Int. Cl. G09B 7/02; G06F 40/40

(52) U.S. Cl. CPC G09B 7/02; G06F 40/40

(57) ABSTRACT

Systems and methods of a user manual for interacting with users of a product or service are disclosed. An identifier is used to identify a user manual and to be read by an end user to establish a connection between the user and the system of user manual. A user interface is installed in a terminal device and used to receive prompts from the end user and display information of the user manual. An artificial intelligence co-pilot program is coupled with the user manual and trained to communicate with end users in natural language about information of the user manual via the user interface. Such communication is interactive in response to user prompts. Such communication may further lead to human-to-human interaction between end users with customer support, service providers, etc.

### TECHNICAL FIELD

The embodiments provided herein a system and a method of a smart user manual to interact with an end user about a product or service, and more particularly, a method utilizing artificial intelligence (AI) co-pilot program to provide interactive communication in natural language with an end user in relation to a product or service.

### BACKGROUND

Customer service is a critical link of obtaining customer satisfaction and retaining customers for continuous future business of any product or service providers. Generally speaking, customer services comprise guiding the use of the product or service, accessing warranty information, troubleshooting, requesting maintenance services, ordering supplies and disposable replacement parts, connecting consumers with local service team or live remote supporting personnel, and many more.

Traditional paper-based user manual can provide baseline information of a product or service. However, it has numerous disadvantages in the current digital era. It is a paper-based physical document, making it inaccessible to users who don't have the physical document in hands. Updating paper-based user manuals is a cumbersome process requiring reprinting and redistributing. As a result of the time-consuming and costly process, many users have outdated information in hands. Furthermore, static information provided by paper-based user manual is lack of interactivity at all. Users may find it challenging to navigate through dense text to locate specific information efficiently.

Later on, customer service migrated to electronic forms. Often times, customer services are provided by the combination of a website on the internet and a customer support telephone number. Part of the problems with traditional paper-based user manual are solved. For example, the internet website can be updated periodically, to keep up with the latest developments or updates of the products or services. Accessibility becomes better as well since a user can check the user manual wherever there is access to the internet. Users could more easily search through the user manual to quickly identify relevant information that is in need. However, interactivity is by and large achieved only by communications with customer support personnel via telephone calls.

Thereafter, some websites adopted chatbots as interactive customer service. Consumers turn to online chatbots for guidance on how to use the product or service. Chatbots can vendor direct answers if questions consumers asked fall into the scope of stored data or programmed content. However, several drawbacks are associated with online chatbots. The ability of chatbot to accurately interpret and understand users' queries in natural language is very limited. For example, a chatbot lacks appropriate understanding of context over a conversation and hence it can't handle multi-turn interactions effectively with users. For another example, a chatbot also struggles to understand and appropriately respond to complex human emotional cues.

Last, it is about learning capability. It is desired to have a chatbot system adapt to new queries and user behavior, so that chatbots can continuously expand capabilities and learn from interactions with end users.

To maintain or achieve a higher level of a customer's satisfaction about his/her user experience of a product or service, there is a need to continuing improving accessibility, interactivity, and practicality of the user manual system and the way to provide customer support, and ultimately to improve the user experience of the product or service.

### SUMMARY

Generally provided are a system and method of user manual to interact with an end user of a product or service. A digital identifier is used as a portal to easily connect an end user with the smart user manual system. User interface software in a terminal device is used as a platform where an end user interacts with the smart user manual system. Preferably, an AI co-pilot program is adopted by the user interface software of the user manual system. More preferably, a Large Language Model (LLM) of AI algorithm is adopted to process communication with end users in natural languages. These embodiments can yield high efficiency, smooth interactivity, and ultimately customers' satisfactory user experience with fewer interruptions by human beings.

In accordance with a further embodiment, a method to train the AI co-pilot program is proposed. The AI co-pilot algorithm adopts LLM as a part of the training. Information of an Application Programming Interface (API) is input to the AI co-pilot. Moreover, some static information or data is input to form the baseline of the model. Such static information comprises static business knowledge of a product or service, domain knowledge about the industry of which the product or service belongs to, and language tone which is suitable for provision of customer service. The method to train the AI co-pilot program can be applied whenever necessary to keep the static information up to date.

In accordance with a further embodiment, a method for users to interact with a user manual system is provided. The method includes the steps of reading a user manual identifier, establishing a connection between a user and a user manual system with a user interface, receiving user prompts, processing prompts by an AI co-pilot, and generating and delivering responses. This step improves the system's understanding of context, capability of handling emotional cues, and use of appropriate tones, etc.

In accordance with a further embodiment, a system of user manual that interacts with an end user following the aforementioned interacting method, and with responses came up with by the aforementioned trained AI co-pilot program is proposed.

In accordance with a further embodiment, the generated and delivered response to an end user is an action to be taken by an AI co-pilot, following the aforementioned interacting method, and with responses came up with by the aforementioned trained AI co-pilot program.

This summary is provided to efficiently present the general concept of the invention and should not be interpreted as limiting the scope of the claims.

### BRIEF DESCRIPTION OF THE DRAWINGS

For purpose of facilitating understanding of the embodiments, the accompanying drawings and description illustrate embodiments thereof, its various structures, construction, method of operation, and many advantages that may be understood and appreciated. According to common practice, the various features of the drawings are not drawn to scale. To the contrary, the dimensions of the various features are arbitrarily expanded or reduced for clarity.

FIG. 1 is a diagram of the architecture of the smart user manual system in accordance with aspects of the invention for enhanced customer service user experience;

FIG. 2 is a workflow of using AI co-pilot program of the smart user manual system to handle user input and take actions in accordance with aspects of the invention for enhanced customer service user experience;

FIG. 3 is a diagram of training the AI co-pilot program used in the smart user manual system in accordance with aspects of the invention for enhanced customer service user experience.

### DETAILED DESCRIPTION

Many alternative embodiments of the present aspects may be appropriate and are contemplated, including as described in these detailed embodiments, though also including alternatives that may not be expressly shown or described herein but as obvious variants or obviously contemplated according to one of ordinary skill based on reviewing the totality of this disclosure in combination with other available information. For example, it is contemplated that features shown and described with respect to one or more embodiments may also be included in combination with another embodiment even though not expressly shown and described in that specific combination.

For purpose of efficiency, reference numbers may be repeated between figures where they are intended to represent similar features between otherwise varied embodiments, though those features may also incorporate certain differences between embodiments if and to the extent specified as such or otherwise apparent to one of ordinary skill, such as differences clearly shown between them in the respective figures.

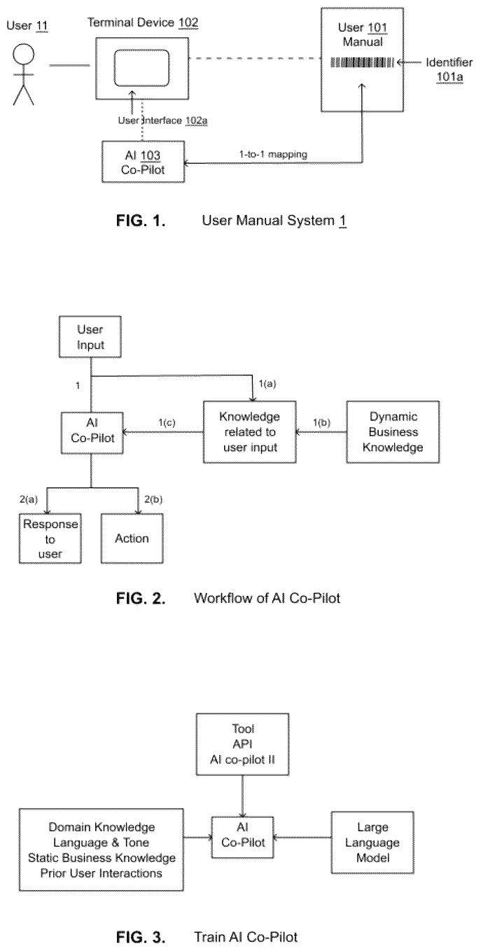

Reference is now made to FIG. 1, which is diagram illustrating an architecture of the proposed smart user manual system, in accordance with aspects of the invention for enhanced customer service user experience and consistent with embodiments of the present disclosure.

User manual system 1 depicts a user manual 101, an identifier of the user manual 101a, a terminal device 102, a user interface installed in the terminal device 102a, an AI co-pilot coupled with the user manual 103.

User Manual System 1 is purported to provide End User 11 of a product or service with information related to product or service purchased or licensed from the product manufacturer, service provider, or third-party platform. Such information generally is needed after a sale or lease transaction happens but could also be needed prior to that. In some scenarios, a user wants to generally know more about the product or service at hand. For instance, origin of the product, brand history, warranty information, price of product, cost of maintenance, etc.

In some other scenarios, an end user wants or needs to understand how to operate a product or use a service, be it some furniture to be assembled, or a coffee machine, or an online meditation session, etc. In some other scenarios, customers may change their minds about the purchase or license transaction, the user manual system can help file a return request. In some other scenarios, customers or users need some real-time technical support to trouble shoot malfunctions of a product, during office hours of customer support personnel or off office hours. During office hours, customers may receive live chat customer support from business personnel. During office hours, customers may follow guidance of the user manual system to troubleshoot by themselves. If no success, a customer support request ticket may be filed on behalf of a customer. In yet some other scenarios, customers or users need to take some actions for continuous use of the product or service. Some examples are ordering disposable parts (e.g., replacement blades of a shaver), requesting local service providers' on-site support for complex problems; buying extended warranty, and accessing recall information.

As a first step for a user to utilize the smart user manual system, the end user has to be connected to the user manual system. Identifier 101a serves as the portal to establish communication between end users and the user manual system. It is configured to identify User Manual 101 to users. Identifier 101a is uniquely associated with the product or service or the product manufacturer or service provider' business at users' hands. Identifier 101a is configured to accurately link and direct end users to the user manual system it is uniquely associated with. Like revealed by its name, it can be viewed as an identifier users use to identify the user manual system. Identifier 101a can be placed at a location arbitrarily by product manufacturer, service provider, or third-party merchant. In some embodiments, Identifier 101a is printed on the package of a product or the appearance of a product. When users receive a product and access Identifier 101a, users are directed and connected to User Manual System 101 without hiccups. In some other embodiments, Identifier 101a can be provided at a website marketing relevant products or services, or a manufacturer or a third party's mobile application programs, or be a part of printed or physical marketing materials like billboards, pamphlets, flyers.

Identifier 101a comprises a serial of numbers, letters, symbols, RGB pixels, or the combination of any thereof. In some embodiments, Identifier 101a is readable and operable by human beings. Examples in these embodiments include website address in form of Uniform Resource Locator (URL) and similar. Users can read the URL address and key it into a web browser. Users can also use software application programs to read and open the URL automatically. The operation will lead users to the user manual system. In some other embodiments, Identifier 101a is a computer-readable-and-scannable code, such as barcode, Quick Response (QR) code, image, and similar. Image processing camera is one exemplary reader of scannable codes. In yet some other embodiments, Identifier 101a is a machine detectable tag electronically or magnetically. For example, Near Field Communication (NFC) tag, cellular wireless telecommunication powered asset stickers, and similar. Infrared code readers that read electromagnetic radiation signals can be adopted for this purpose too.

User Interface 102a comprises API that is configured to allow users of the product or service to interact with User Manual System 1. Often times, such API is a computer program programmed by a product manufacturer, a service vendor, a third-party merchant, and installed in Terminal Device 102. In some embodiments, User Interface 102a is a web-based program. End users can explore static information on the webpage. End users can further play around or operate on interface portal on the website, e.g., input field, selection button, etc. In some other embodiments, User Interface 102a is a downloadable application program in an application marketplace of an Operating System (O/S) of a smart phone, a Virtual Reality or Augmented Reality (VR/AR) headset, etc.

User Interface 102a is configured to receive user prompts. User prompts can be received in multiple forms. In some embodiments, users input their questions, commands, or responses to the system by typing, writing, or drawing on an input panel of User Interface 102a. In some other embodiments, User Interface 102a is configured to receive users' audio input like voice command and similar. Users talk in their natural language(s) and User Interface 102 is configured to process audio signals and convert them to data to be further processed by User Manual System 1. In some other embodiments, User Interface 102a is configured to receive digital materials, such as images or video input users obtain from separate resources and feed these files to User Interface 102a. In some other embodiments, User Interface 102a is further configured to scan users' body language, facial expressions, gestures or movements and convert them to data to be further processed by User Manual System 1. Other suitable ways to collect user input will be understood by one of skill in the same art.

User Interface 102a is further configured to deliver information and responses of User Manual System 1 to end users. Similar to prompt receiving functions, User Interface 102a can deliver information and responses to end users in multiple forms that human beings can appreciate and comprehend. In some other embodiments, User Interface 102a is configured to display text or picture response in an output panel of User Interface 102a. Users are allowed to browse the responses at their own pace, e.g., read, re-read, or pause the messages. In some other embodiments, User Interface 102a is configured to play audio or video-based response by an output device. Similarly, users are enabled to receive the audio or video-based response at the pace they wish, to play, fast forward, backward, re-play, pause, or take similar actions on these responses. In yet some other embodiments, other ways to output responses may be tailor made to suit and serve users with special needs, e.g., users with hearing difficulties, illiterate or with reading difficulties, etc. Other suitable types of output device will be understood by one of skill in the same art.

Terminal Device 102 provides a physical interface to enable interactions of users with User Manual System 1. The physical interface materializes the interactions users have with User Manual System 1 via User Interface 102a by input and output apparatus. In the embodiments when prompts from users are typed to User Interface 102a, a physical or virtual keyboard is adopted as a part of Terminal Device 102. In the embodiments when prompts from users are written or drawn to User Interface 102a, a physical or virtual drawing pad is adopted as a part of Terminal Device 102. In the embodiments when prompts from users are voice command, Terminal Device 102 is equipped with a microphone or a sensor that shares the same function to convert audio signals to electric signals. In the embodiments when prompts from users are body language, facial expressions, gestures or movements, or a video clip or a photo about a defect product or tricky technical issue users encounter, Terminal Device 102 is equipped with a camera or image sensor to capture visual signals and convert them to electric signals.

Similarly, Terminal Device 102 is configured to provide responses and deliver information to end users in various modes or forms that human beings can appreciate and comprehend. In the embodiments when text or picture responses are output to end users, Terminal Device 102 is installed with a physical or virtual display or screen. In the embodiments when audio or video-based responses are sent to end users, a speaker and/or a physical or virtual display or screen is used to convert electric signals to audible sound and/or visual information. In the embodiments when output responses are tailored to suit end users with special needs, special output devices can be adopted, such as bone conduction headset or similar.

In some embodiments, Terminal Device 102 is a generic terminal device. Some examples of generic terminal devices include smartphones, tablets, personal computers, VR/AR headsets, smart cars, smart home appliances, etc. In some other embodiments, Terminal Device 102 is a terminal device that is designed and made for special purposes. One good example of this category is tools used by the group of people with special needs.

Notably, the device or interface an end user uses to read Identifier 101a does not need to be the same device as Terminal Device 102, although it can be the same. Or in another preferred embodiment, it may be preferrable to be the same by end users for the convenience of operation or simplification and reduction of device or interfacing apparatus.

Mapped uniquely with Identifier 101a is AI Co-Pilot 103. Once a user uses Terminal Device 102 to read Identifier 101a and gets connected to User Manual System 1 via User Interface 102a, AI Co-Pilot 103 takes charge of the interaction with the user. AI Co-Pilot 103 is configured to improve the satisfaction of user experience, boost efficiency of customer services, and ultimately enhance accessibility, interactivity, and practicality of User Manual System 1.

AI Co-Pilot 103 is a software program utilizing a conversational interface based on LLM algorithms to assist users in various tasks by providing context-aware assistance, automating mundane tasks, analyzing data, and enabling smooth communication. It is designed to work seamlessly with User Interface 102a and other parts of User Manual System 1, offering real-time assistance without disrupting User 11's communication process. AI Co-Pilot 103 is mapped with Identifier 101a. When Identifier 101a is read, User Manual System 1, via User Interface 102a, will lead User 11 to interact with AI Co-Pilot 103. Identifier 101a is uniquely mapped with AI Co-Pilot 103, not any other AI assistance algorithms or models.

In some embodiments, the AI co-pilot program is a remote web-based or cloud-based solution. AI Co-Pilot 103 is remotely stored in a server that provides cloud service. AI Co-Pilot 103 is located away from End User 11. User 11 interacts with User Manual 101 through Terminal Device 102 which is electronically or magnetically connected to AI Co-Pilot 103.

In some other embodiments, AI Co-Pilot 103 is an edge AI solution, meaning, AI co-pilot algorithm 103 is stored in an edge computing environment. In some embodiments, such edge computing environment may be separate from Terminal Device 102 but can be of close proximity of Terminal Device 102 and coupled with Terminal Device 102 electrically or magnetically. In some other embodiments, such edge computing environment can be Terminal Device 102 itself. Similarly, AI Co-Pilot 103 is a part embedded in Terminal Device 102 and coupled with other parts of Terminal Device 102 electrically or magnetically.

The system architecture of FIG. 1 is meant to be exemplary and non-exclusive. One of skill in the art reasonably contemplate that other system configurations may be used in accordance with aspects of the present invention for enhanced customer service user experience.

Reference now is made to FIG. 2. FIG. 2 is a workflow of using AI co-pilot program of the smart user manual system to handle user input and take actions in accordance with aspects of the invention for enhanced customer service user experience. In any interaction session between User 11 and User Manual System 1, a trained AI co-pilot program is configured to take multiple steps to process input received from end users and respond accordingly and take further actions on behalf of end users if the algorithm decides appropriate.

At Step 1, AI co-pilot program receives user input from an end user in relation to information about a product or service. Often times, user input is a prompt, a question, or an enquiry regarding the product or service. At Step 2(a), the trained AI co-pilot program is configured to provide responses to the user. In some embodiments, the response is an answer to questions asked by end users. For example, introducing product's features, briefing procedures of a function of the product, or explaining how to do a regular maintenance of the product, etc.

Alternatively, after Step 1, at Step 2(b), the trained AI Co-Pilot is configured to take actions on behalf of end users. In some embodiments, AI co-pilot program determines that a follow-up action is an appropriate response to user's prompt. For example, after AI co-pilot program assesses the severity of a problem the user raised, the AI co-pilot program classifies the problem into different triage levels. If a problem is decided to be of certain severity level, the AI co-pilot program may direct the communication with the end user to a live chat channel which connects the end user with a customer service representative, i.e., a human being. For another example, the prompt received from user is an instruction to claim warranty. In this case, the AI co-pilot program may file a warranty claim if the AI co-pilot program checks and confirms the warranty is still within its valid period of time. For another example, the prompt received from user is a complex technical question and the AI co-pilot program decides an on-site support is needed. In this case, the AI co-pilot program may proceed to schedule an on-site service session. For yet another example, the prompt received from user is a complaint about a disposable part. In this case, the AI co-pilot program may order supplies or replacement parts for the user.

Various possible situations the AI co-pilot program is configured to handle are further described here. In one embodiment, Step 1 is not necessarily required to happen prior to Step 2. The AI co-pilot program may send greetings to an end user once the user connects to the User Manual System, even if the user has not initiated a conversation yet. The AI co-pilot program may also proactively send users reminders for upcoming service appointments and similar. In some embodiments, the AI co-pilot program is configured to work as a virtual interactive user manual. The AI co-pilot program, through questions and answers with a user, understands the technical problem of the product or service, and advises the user on appropriate course of actions step by step. In some other embodiments, after technical problems being classified, based on their triage level, the AI co-pilot program may guide users to file a support ticket, or to get users connected to customer service representatives for real-time assistance through a live chat, or to facilitate users to request professional service or repairs, or further to connect users with local service providers or authorized repair centers. Other suitable types of interactions between the AI co-pilot program and users will be understood by one of skill in the same art.

In another embodiment, an additional step takes place when user input is received by the AI co-pilot program, in parallel with direct and immediate receiving input and delivering output. At Step 1(a), user input is sent to a database storing knowledge related to user input. In these embodiments, communication with users provides the AI co-pilot program context of users' enquiries. To further identify an appropriate response to users, a dynamic business knowledge base is referred to at Step 1(b). Dynamic business knowledge is information stored in a knowledge base which is business information related to a product or service and which is dynamic and changeable over time. One good example of dynamic business knowledge is pricing information. Another example of dynamic business knowledge relates to local technical support or customer service network, e.g., local handymen's contacts, service scope, and quotations. Thereafter, the AI co-pilot program is configured to narrow relevant information down to knowledge related to users' input. The focused knowledge related to user input is further used in Step 1(c) to form the final response the AI co-pilot program is going to provide to users.

With reference made to FIG. 3 now, this figure demonstrates how the AI co-pilot program used in the smart user manual system can be trained in accordance with aspects of the invention for enhanced customer service user experience.

Training of the AI co-pilot program comprises at least three aspects, the model or algorithm, the knowledge base, and the understanding of tools. In some embodiments, the artificial intelligence algorithm adopted by the user manual system is Large Language Model. LLM is an artificial intelligence algorithm specializing in its general-purpose language generation capabilities. The model acquires abilities through learning statistical relationships from text documents in the training process. The model is generally trained through massive data sets to comprehend and generate human language text. Due to the model's specialty in processing, comprehending, and corresponding in natural languages of human beings, the model is specifically fit for the industry and business of customer services which require understanding, communication, and interaction with human beings in their human languages. LLM serves as a solid starting point to train the AI co-pilot program. However, there are also challenges associated with LLMs such as bias, hallucination, and complexity that lead to inaccurate or misleading responses. Hence, there is always a desire to further improve or identify better artificial intelligence algorithms for the proposed application and disclosure here. And any other suitable types of artificial intelligence algorithms in accordance with aspects of the invention will be understood by one of skill in the same art.

The AI co-pilot program is configured to acquire information from multiple knowledge bases, namely, domain knowledge, natural languages and tones, static business knowledge, and more. Domain knowledge includes knowledge about a specific industry or market which the product or service the user manual system is related to concerns. For example, different industries have different time cycle of business, sensitivity to price, customer needs of support, etc. Similarly, different markets, countries, or regions have different distribution networks, marketing strategies, consumer habits, business etiquettes, etc. Without training data of the domain knowledge, the AI co-pilot program is a bare bone program which can only understand general human languages, but not specific information about the product or service it is designed to support with enhanced customer service experience.

Comprehending natural languages and tones is another critical capability the AI co-pilot program is configured to have. Powered by LLMs, the AI co-pilot program is designed to understand, process, communicate, and interact in multiple natural languages human beings speak. Moreover, cultures associated with various natural languages are vastly different. As a result, tones of consumers, i.e., end users of the user manual system, are distinctly different too. For example, people from certain cultural backgrounds may still use polite and formal wording in their language even when they feel upset and dissatisfied about a product or service; while people from some other cultural backgrounds may use swear words when they feel especially happy about what they receive from a product or service. On the flip side, different companies and merchants have different branding strategies and cultures. Hence, the language and tone of their customer support personnel use are also different. The AI co-pilot program is configured to learn up companies' branding, cultural, and usage of language. Through the training of natural languages and tones associated thereof, the AI co-pilot program is configured to obtain societal cues during the interactions with users, reduce dissatisfaction and frustration customers often feel when dealing with normal chatbots, and further enhance customer service experience.

Another aspect of knowledge the AI co-pilot program is trained with is static business knowledge. As opposed to dynamic business knowledge discussed earlier above, static business knowledge is information about a business, product, or service that is almost constant and requires minimum frequency of updating. Static business knowledge comprises regular information of a product or service, a product manufacturer, a service provider, business contacts, product or service introduction, user manual information of a product model, lines of product or service, etc. Because this type of information is seldom changed and desired to be kept the same for continuity reasons, it forms the fundamental training database of the AI co-pilot program. The AI co-pilot program is trained in static business knowledge and configured to provide such information to users instantly upon request or once the AI co-pilot program identifies such information is needed to respond to user enquiries. However, although static, it is not that static business knowledge never changes. To this, the AI co-pilot program can be re-trained once in a while to keep the static information up to date. Also noted, the distinguish between static business knowledge and dynamic business knowledge is arbitrary and determinable by a business. On occasions, all business knowledge could be treated as dynamic. It is a balance of cost and practicability to decide between retraining and using dynamic knowledge.

Moreover, in some other embodiments, although not illustrated in FIG. 3, the training of AI co-pilot program is dynamic and continuous. The AI co-pilot program is configured to continue receiving dynamic business knowledge and prompts from users, and to continue building responses on top of previous response the AI co-pilot program provides. The dynamic training process may happen at the same time when the User Manual System interacts with users.

Still with reference to FIG. 3, the AI co-pilot program is trained with information about API of the user manual system, APIs and/or tools of third-party businesses. The purpose of the training is two-fold. One is that the AI co-pilot program needs to interact with users of the user manual system through its API. Without such training, the AI co-pilot program is not configured to be integrated and work together with the user manual.

The other purpose of training the AI co-pilot program with data and information of APIs and/or tools of third-party businesses is to enable the user manual system to work with a third party and take further actions on behalf of users. For instance, the user manual system is configured to link to a third-party merchant's online store via the merchant's API. Therefore, when the AI co-pilot program decides that a supply or replacement part is needed, the user manual system is technically enabled to complete an order from the third-party merchant's online store via communication through the merchant's API. For another instance, the user manual system is configured to link to a third-party platform or marketplace assembling local service vendors, or an online remote troubleshooting service vendor. Therefore, when the AI co-pilot program determines an on-site service, maintenance, or repair is needed, the user manual system is technically enabled to initiate a request for service and quotation from the third-party platform or marketplace via communication through the platform or marketplace's API, or from the online remote troubleshooting service vendor via communication through the vendor's API.

Importantly, the third-party API or tool can be another AI co-pilot program that functions independently from the AI co-pilot program of the user manual system a user has in hand. The AI co-pilot program is configured to consult, communicate with, and learn from another independent AI co-pilot program if complexity is decided to be beyond scope. Any other suitable use cases and scenarios in accordance with aspects of the invention can be understood by one of skill in the same art.

Although the invention is illustrated and described herein with reference to specific embodiments, the invention is not intended to be limited to the details shown. Rather, various modifications can be made in the details within the scope of equivalents of the claims by anyone skill in the art without departing from the invention.

What is claimed:

1. A system of user manual, comprising:
a user manual, comprising product or service information;
an identifier, configured to identify said user manual and to be read to establish a connection between a user with said system of user manual;
a user interface installed in a terminal device, configured to receive user prompt and deliver information of said user manual;
wherein the information of said user manual is interactive in response to user prompt and generated by an artificial intelligence co-pilot program (defined below) in relation to said product or service information; and
an AI co-pilot program, coupled with said user manual, configured to communicate with a user in natural language in relation to information of said user manual via said user interface.

2. The system of claim 1, wherein said identifier comprises serial numbers, letters, symbols, RGB pixels, or the combination of any of the four.

3. The system of claim 1, wherein said terminal device is a smart phone.

4. The system of claim 1, wherein said terminal device is a VR/AR headset.

5. The system of claim 1, wherein said artificial intelligence co-pilot program is trained on the specific said product or service information, brand information of the provider of said product or service, protocols of customer support of said provider of product or service, and user prompt.

6. The system of claim 1, wherein said artificial intelligence co-pilot program is remotely located and electrically or magnetically coupled to said terminal device.

7. The system of claim 1, wherein said artificial intelligence co-pilot program is located in said terminal device.

8. The system of claim 1, wherein said artificial intelligence co-pilot program is located in a second terminal device, whereas said second terminal device is electrically or magnetically coupled to said terminal device.

9. A method for interacting with user of a product or service, comprising:
reading an identifier of a user manual;
establishing a connection between a user and a system of user manual with a user interface; receiving a prompt from a user about product or service information;
processing said prompt by an artificial intelligence co-pilot program;
generating response by said artificial intelligence co-pilot program to said prompt; and delivering said response via said user interface.

10. The method of claim 9, further comprising:
training said artificial intelligence co-pilot program with specific said product or service information, brand information of the provider of said product or service, and protocols of customer support of said provider of product or service.

11. The method of claim 10, further comprising:
collecting said prompt by said user interface; and
training said artificial intelligence co-pilot program with said prompt.

12. The method of claim 9, further comprising:
displaying greeting information on said user interface prior to receiving a prompt from a user.

13. The method of claim 9, wherein said receiving, processing, generating, and displaying steps are repeated.

14. The method of claim 9, further comprising:
directing said user to a live chat supported by human being.

15. The method of claim 9, further comprising:
connecting said user with a service provider.

16. The method of claim 9, further comprising:
taking action on behalf of said user.

17. A non-transitory computer readable medium including a set of instructions that are executable by one or more processors of a computer to cause the computer to perform a method for interacting with user of a product or service, the method comprising:
reading an identifier of a user manual;
establishing a connection between a user and a system of user manual with a user interface; receiving a prompt from a user about product or service information;
processing said prompt by an artificial intelligence co-pilot program;
generating response by said artificial intelligence co-pilot program to said prompt; and displaying said response on said user interface.

18. The method of claim 17, further comprising:
training said artificial intelligence co-pilot program with specific said product or service information, brand information of the provider of said product or service, and protocols of customer support of said provider of product or service.

19. The method of claim 18, further comprising:
collecting said prompt by said user interface; and
training said artificial intelligence co-pilot program with said prompt.

20. The method of claim 17, further comprising:
displaying greeting information on said user interface prior to receiving a prompt from a user.

21. The method of claim 17, wherein said receiving, processing, generating, and displaying steps are repeated.

22. The method of claim 17, further comprising: directing said user to a live chat supported by human being.

23. The method of claim 17, further comprising:
connecting said user with a service provider.

24. The method of claim 17, further comprising: taking
action on behalf of said user.
